(19) United States
(12) Patent Application Publication
(10) Pub. No.: US 2024/0301966 A1
(43) Pub. Date: Sep. 12, 2024

(54) ACTUATING DEVICE FOR ACTUATING VALVES

(71) Applicant: Neoperl GmbH, Müllheim (DE)

(72) Inventor: Adrijan STRMSEK, Maribor (SI)

(73) Assignee: Neoperl GmbH, Müllheim (DE)

(21) Appl. No.: 18/282,009

(22) PCT Filed: Mar. 15, 2022
(86) PCT No.: PCT/EP2022/056718

§ 371 Date: Sep. 14, 2023

(30) Foreign Application Priority Data
Mar. 18, 2021 (DE) 202021101386.9

(51) Int. Cl. F16K 35/14; E03C 1/02; E03C 1/04; F16K 11/22; F16K 31/56

(52) U.S. Cl. CPC F16K 35/14; E03C 1/0408; F16K 11/22; F16K 31/56; E03C 2001/026

(57) ABSTRACT

In order to simplify the operation of a valve assembly (2) which includes a plurality of valves (3) that have respective activating elements (8) which serve for in each case manually opening the valves (3), the activating elements are temporarily blocked with the aid of at least one shut-off part (6) so that an activation of at least one of the other valves (3) of the valve assembly (2) is currently precluded.

### CROSS-REFERENCE TO RELATED APPLICATIONS

This application is a 371 National Phase of International Application No. PCT/EP2022/056718, filed Mar. 15, 2022, which claims priority from German Patent Application No. 20 2021 101 386.9, filed Mar. 18, 2021, both of which are incorporated herein by reference as if fully set forth.

### TECHNICAL FIELD

The invention relates to an activating device for activating at least two valves of a valve assembly.

The invention furthermore relates to a further activating device for activating at least two valves of a valve assembly having in each case one activating element for opening a respective one of the at least two valves, wherein the valves are in each case configured to be self-closing. The first-mentioned activating device can also be configured with these features.

### BACKGROUND

Activating devices of this type are known per se in the prior art and are used in particular to switch on or switch off different water paths by means of the valves. Such a requirement is present, for instance, in shower rooms where different shower outlets of a sanitary fitting are to be supplied with water by means of an activating device as explained at the outset.

There is often a regulatory-based or standards-based requirement for such applications that two valves of the valve assembly should not, or must not, be able to be opened simultaneously by means of the activating device.

### SUMMARY

Proceeding therefrom, the invention is based on the object of enabling improved handling, or activating, of valves of a valve assembly, which is user-friendly on the one hand, and meets the regulatory-based or standards-based requirements on the other hand.

In order for this object to be achieved, one or more of the features disclosed herein are provided according to the invention in an activating device. In order to achieve the object it is thus in particular provided according to the invention in an activating device of the type mentioned at the outset that by activating one of the at least two valves in an activating device a shut-off element of the activating device is movable to a shut-off position. It is furthermore proposed that an activation of at least one, but preferably of all other, of the at least two valves is blocked as soon as the shut-off element is in the shut-off position.

The activating device can preferably be designed as a manual device which is manually activatable. In contrast, the shut-off element can be in multiple parts, i.e. assembled from a plurality of (in the simplest case from two) shut-off parts. As a result, the shut-off element in each of the valves can be individually sub-divided or isolated, for instance to shut off respective adjacent valves.

In such a design embodiment it is advantageous that simultaneous opening of a plurality of the valves is able to be reliably prevented by the activating device.

In other words, it is thus proposed according to the invention that a shut-off element is movable to different shut-off positions, wherein in each of these shut-off positions a respective one of the valves of the valve assembly is still activatable, i.e. in particular able to be opened, while at least one valve, but preferably all other valves, of the valve assembly in this shut-off position are currently blocked and thus cannot be activated or opened, respectively. The same then applies in an analogous manner to the further possible shut-off positions, wherein the number of possible shut-off positions of course increases as the number of valves of the valve assembly increases.

According to the invention, the object can also be achieved by further advantageous embodiments according to the description and claims that follow.

For example, at least one shut-off part of the shut-off element can be designed as a displacement part and/or be displaceable to the shut-off position.

Additionally or alternatively, it can also be provided that at least one shut-off part of the shut-off element is designed as a pivot part and/or is pivotable to the shut-off position. In such a case, the at least one pivot part can in particular be mounted such that it is pivotable on a circular path.

The invention furthermore proposes an activating device which is conceived for a valve assembly having at least three valves. The shut-off element here possesses at least two shut-off parts which by a respective activation of a respective one of the at least three valves are displaceable to a respective shut-off position. It is furthermore provided here that an activation of at least one, but preferably of all other, of the at least three valves is blocked as soon as one of the shut-off parts is in its shut-off position.

As has already been mentioned, the activation of one of the valves of the valve assembly can cause opening of this valve. It can be achieved in particular as a result that a water flow from a common inlet which supplies all valves can flow through the opened valve.

It can thus be provided that each of the at least two valves can be individually opened, and preferably closed, by means of the activating device, i.e. in particular by means of the assigned respective activating elements.

It can furthermore be provided that each of the at least two valves is able to be blocked by means of the shut-off element. This can preferably take place in such a way that each of the at least two valves is able to be blocked by means of each of the at least two shut-off parts.

During a blockage of a respective one of the valves, opening this blocked valve by activating the activating element associated with this valve can thus be prevented in each case. It can thus be achieved as a result that always only one of the valves can be opened, i.e. in particular be activated by a user, at a specific point in time. This is because opening one of the valves thus causes a blockage of all others of the valves, specifically by means of the shut-off element.

In other words, the blockage of the non-activated valves of the valve assembly can be cancelled, or able to be cancelled, by closing a respective one of the currently opened valves of the valve assembly.

The shut-off element, i.e. in particular the shut-off parts, can in each case be movable in a shut-off direction to the (respective) shut-off position. In the case in which the shut-off parts are designed as displacement parts, as well as in the case in which the shut-off parts are designed as pivot parts, this shut-off movement direction can run transversely to the activating direction, i.e. in particular to a respective activating direction in which the activating elements of the activating device are activatable. This means that the valves can be opened by means of respective activating elements, and that the activating elements move (either slide or pivot) the shut-off element, i.e. in particular at least one respective shut-off part of the shut-off element, to the shut-off position. The activating elements here can be designed as push buttons, for example. When the activating elements are depressed, the latter pivot or displace a respective assigned shut-off part of the shut-off element.

In such a design embodiment it is preferable for a respective deflecting element, for example in the form of an oblique face, is configured for this purpose on each of the activating elements. This deflecting element can in each case convert a linear activation of the respective activating element in the activating direction (for example a pushing action) into a respective shut-off movement of at least one of the shut-off parts. The shut-off movement of one of the shut-off parts here can be transmitted to other ones of the shut-off parts of the shut-off element, for instance in that the shut-off part, actuated by the activating element, nudges or pivots the other shut-off parts. This means that a respective shut-off part which is currently actuated by way of an activating element in this instance actuates the other shut-off parts.

In this way, a situation can be created in which, for example, when activating a central one of the valves, the shut-off movements of at least two of the shut-off parts are performed in opposite directions, specifically when, for example, the activating element associated with the valve diverges the two shut-off parts. Furthermore, the situation can also be created in which, when activating an outermost one of the valves (thus the valve which is disposed in an outer position of the valve assembly), the shut-off movements of all shut-off parts are performed in the same direction (for example, all shut-off parts thus move from the left to the right because the left outermost shut-off part likewise moves from the left to the right), specifically in particular owing to an actuation by one of the activating elements.

Furthermore, all shut-off parts can in particular be designed with the same shape and/or all activating elements can be designed with the same shape, as a result of which production costs can be saved.

A further design embodiment provides that the shut-off parts are in each case movable to two shut-off positions which serve for blocking a respective adjacent valve. In this way, one shut-off part can block a valve on the left of the shut-off part, and a further valve on the right of the shut-off part, for example, specifically in each case by a movement to the left and to the right, respectively. The same applies in an analogous manner to a pivoting movement of a shut-off part in the clockwise direction or counter thereto.

The activating elements can in each case be guided in a linear manner, for example, so that movements of the activating elements transverse to the activating direction are precluded.

In a design embodiment of this type it is preferable for the shut-off element, i.e. in particular the at least two shut-off parts of the shut-off element, to be likewise guided in a linear manner so that movements of the shut-off parts, or of the shut-off element, in the activating direction are currently precluded, respectively. This is possible in the case of shut-off displacement parts, as well as shut-off pivot parts.

As a result of the aforementioned design embodiments it can be achieved in particular that all valves are blocked by means of the shut-off element when any two of the activating elements are simultaneously activated. As a result, it can be achieved specifically that no two valves can be simultaneously opened. It is preferable here for the shut-off element to establish and operate a connection between the activating elements. This can thus mean that the shut-off element transmits shut-off forces emanating from one of the activating elements to the other activating elements, for instance in order to retain these other activating elements in the respective shut-off position.

A further potential design embodiment provides that the activating elements actuate a respective actuator element which is designed for opening the respective valve only from a second portion of an activating movement, this being imparted by respective assigned intermediate elements. In such a case it can be provided that the activating elements in a first portion of the activating movement are displaceable relative to the respective assigned intermediate element. It can be achieved as a result that the blockage of the other valves takes place during the first portion of the activating movement, i.e. even before a valve to be opened is opened by the activating movement of one of the activating elements (this being able to take place only in a second portion of the activating movement). In this way, a respective activating element and the assigned intermediate element can move conjointly in the second portion of the respective activating movement. To this end, a respective driver can be configured on each activating element, for example, which driver entrains and thus actuates the intermediate element from the second portion of the activating movement.

A further potential design embodiment of the shut-off parts of the shut-off element provides that the at least two shut-off parts (at least temporarily in specific positions) can contact and thus actuate one another, for instance when one of the shut-off parts is displaced or pivoted or moved to a respective shut-off position. It can furthermore be provided alternatively or additionally that the activating elements are penetrated by the shut-off parts, in particular in such a manner that the shut-off parts can just contact one another.

Furthermore, the at least two shut-off parts can in each case be guided along the shut-off movement direction in a guide. This guide can be formed specifically by the activating elements. The guide here can furthermore permit a displacement of the activating elements, relative to the respective shut-off part, in the activating direction, for instance when the guide in the activating direction is configured to be longer than a height of the shut-off parts.

It can furthermore be provided that the at least two shut-off parts have in each case a support face by means of which the respective shut-off part is mounted so as to be displaceable or pivotable without tilting on a displacement face.

According to a further aspect of the present invention, with a potentially independent inventive character, a further activating device for activating at least two valves of a valve assembly is proposed for achieving the object mentioned at the outset, which can be designed as has already been explained at the outset. As has already been mentioned at the outset, this activating device has in each case one activating element for opening a respective one of the at least two valves, wherein the valves are in each case configured to be self-closing. This activating device can in particular be designed as has already been described above, or according to one of the claims directed toward an activating device. In order to achieve the object mentioned at the outset it is now proposed that the activating device has a retaining mechanism by way of which the valves can be individually retained in a respective opening position. The retaining mechanism here can have a separate releasing element which is characterized in that the releasing element by means of a releasing movement can release each one of the valves. Design embodiments in which the releasing element is actuatable in terms of the releasing movement (i.e. until it has reached a releasing position) by way of each of the activating elements so that the releasing element in this case does not have to be activated per se are also possible.

Alternatively or additionally to the design embodiment of a separate releasing element, it can also be provided that the retaining mechanism (22) can be released by the, preferably by each of the, activating elements (which serve for opening a respective valve). In this way, the retaining mechanism can in particular be designed in such a way that a valve which is currently retained in the open position by the retaining mechanism can be released by activating one of the activating elements of a valve that is still closed. The opened valve can close in a self-acting manner due to the releasing. In contrast, the activation that has triggered the release can allow the previously closed valve to currently move to the open position so as to be retained in the latter again by the retaining mechanism.

As a result of such a retaining mechanism according to the invention it can thus be achieved that one of the valves, which is currently retained in the open position by the retaining mechanism, can be released by activating another currently closed valve and/or by means of the releasing element, i.e. more specifically by means of the releasing movement of the releasing element. As a result, the valve can move in a self-acting manner from the open position to a closed position by virtue of the fact that the valves are in each case configured to be self-closing. For this purpose, corresponding restoring elements, for example in the form of compression springs, which cause the self-acting closing action, can be provided.

When said releasing element is thus in a releasing position, the releasing element can act on the retaining mechanism in such a manner that the latter releases the valve retained in the open position so as to return to a closed position in a self-acting manner.

It can thus be provided that the valves can be retained in a respective open position by means of at least one locking element of the retaining mechanism.

It can be provided in particular that the valves can be retained in the respective open position by means of respective locking elements of the retaining mechanism. These locking elements are designed in various ways, many different exemplary embodiments being known in the prior art.

The at least one locking element can be designed either as a displacement part and/or so as to be displaceable to a locking position, or the at least one locking element is designed as a pivot part and/or pivotable to a locking position. In the case of the second alternative, the at least one locking element can be mounted so as to be pivotable on a circular path, for example.

In this way, a locking movement of the locking element (the former conveying the latter to the locking position) can be a linear movement or else a rotating movement. When a plurality of locking elements are present in the design embodiment, linear movements and rotating movements can also be used for locking the valves.

In contrast, at the end of its releasing movement, the releasing element can transmit an actuating force from one of the activating elements to a locking element of a specific valve. This can take place in particular specifically when this specific valve is currently retained in the open position by the retaining mechanism.

The releasing element can preferably move each of the embodied locking elements from a respective locking position to a releasing position in which the associated valve is currently released (and can thus return to the closed position in a self-acting manner).

One potential design embodiment provides that individual, or else each, of the locking element, form(s) a self-locking ratchet pawl mechanism. For example, this ratchet-pawl mechanism can have a ratchet pawl which is deflectable counter to the restoring force of a restoring element. The ratchet pawl by means of a restoring element can also be brought to engage with a rotatably mounted ratchet wheel of the ratchet-pawl mechanism.

The releasing element per se can likewise be deflectable counter to the restoring force of a restoring element. It can be provided in particular in this case that the releasing element has to be manually actuated in order to release one of the valves for self-acting closing. It can thus be achieved that the releasing element by virtue of the restoring force returns in a self-acting manner in a return movement to an initial position in which the releasing element is spaced apart from the locking elements, specifically as soon as this return movement is released.

The locking elements can preferably be disposed in a common plane. Furthermore, each of the locking elements can act on an associated valve by way of a respective form-fit so as to lock this valve in the open position.

The at least one locking element can preferably be deflectable counter to the restoring force of a restoring element. In this case, the locking element thus has to be manually activated in order to lock one of the valves in the open position.

According to a further potential design embodiment, the shut-off element as well as the releasing element can in each case be embodied by means of at least one displacement part.

A further design embodiment provides that the valves can be retained or locked in the respective open position by means of at least one displacement part and/or by means of at least one pivot part of the retaining mechanism (said displacement part or pivot part functioning as a locking element). It can be provided here that the at least one displacement part (which serves as a locking element) is displaceable in a locking plane, transversely to an activating direction of the activating elements, to a respective locking position, and/or that the at least one pivot part is pivotable in a pivoting plane (=locking plane) which is aligned transversely to the activating direction. In such design embodiments it is furthermore preferable for the at least one displacement part to be able to be displaced by activating one of the activating elements in the activating direction in the locking plane, and/or for the pivot part to be able to be pivoted by activating one of the activating elements in the activating direction in the locking plane. In this case, the respective displacement or pivot part is actuated in the locking plane directly by one of the activating elements.

It can furthermore be provided additionally or alternatively that the at least one displacement or pivot part in the respective locking position engages in respective clearances which are configured in the activating elements. It can be achieved as a result that the activating elements can be locked in an ON position in which an associated one of the valves is retained in the open position.

In contrast, if the at least one displacement or pivot part is mounted in a linear manner, it can be prevented that movements of the at least one displacement part take place in the activating direction so that this type of movements are currently precluded.

By way of the activating devices proposed above it can thus be achieved that an activation of at least one of the activating elements, but preferably all other of the activating elements, is blocked as soon as the at least one displacement part locks one of the activating elements. In this situation, the at least one displacement or pivot part can thus block in particular a respective reach-through window of the blocked activating elements. However, if the reach-through window is released, the respective activating element can be activated through the reach-through window so as to open an associated one of the valves of the valve assembly.

In general, all activating devices proposed up to this point can also be refined by the following features: the valves of the valve assembly can for example be designed as button valves and/or so as to be self-closing, i.e. in particular activated by means of a respective restoring element. A button valve here can be understood to be a valve which has a button as the actuator element for operating the valve. This button can in this instance be specifically activated by one of the activating elements.

Furthermore, the valves of the valve assembly can for example be disposed along a curve, in particular a circular line or an ellipse, or else along a straight line. The disposal on a circular line is expedient, for instance, when the shut-off parts are configured as pivot parts, and/or when the releasing element is configured as a pivot part. In contrast, the disposal along a straight line is expedient when either the shut-off parts are designed as displacement parts and/or the releasing element is designed as a displacement part.

The activating elements can also possess in each case a dedicated restoring element. It can be achieved as a result that the respective activating element has to be actuated counter to the restoring force of the associated restoring element when the respective assigned valve is to be opened. As a result, the respective activating element, by virtue of the restoring force, returns in a self-acting manner to an initial position in which the assigned valve is not activated by the activating element.

According to the invention, an activating device as described above can be particularly advantageously used for activating valves of a sanitary installation, in particular of a shower fitting and/or a tub fitting. In order to achieve the object, a sanitary installation, in particular a shower fitting and/or tub fitting, is therefore also proposed, having an activating device according to one of the claims directed toward an activating device, as well as the use of an activating device according to one of the claims directed toward an activating device on such a sanitary installation.

The invention will now be described in more detail by means of exemplary embodiments but is not limited to these exemplary embodiments. Further configurations of the invention can be derived from the description hereunder of a preferred exemplary embodiment in conjunction with the general description, the claims, and the drawings.

In the following description of different preferred embodiments of the invention, functionally equivalent elements are provided with the same reference signs even differently designed or shaped.

### BRIEF DESCRIPTION OF THE DRAWINGS

In the drawings:

FIG. 1 shows the component parts of a first activating device according to the invention, including an associated valve assembly;

FIG. 2 shows the device from FIG. 1 in an assembled state;

FIG. 3 shows a lateral cross-sectional view of the device from FIGS. 1 and 2;

FIGS. 4 to 9 and 10A-10I show further lateral cross-sectional views of the device from FIGS. 1 and 2 in different states of activation;

FIG. 11 shows a second design embodiment of an activating device according to the invention, including an associated valve assembly;

FIG. 12 shows the device from FIG. 11 when viewed from below;

FIGS. 13 and 14 show the component parts of the second activating device according to the invention;

FIG. 15 shows the second activating device from FIG. 11 in a partial sectional view;

FIG. 16 shows an oblique view onto a cross section through the device from FIG. 11;

FIG. 17 shows the component parts of a third design embodiment of an activating device according to the invention, including an associated valve assembly;

FIG. 18 shows the device from FIG. 17 in an assembled state;

FIG. 19 shows activating elements and shut-off parts of the activating device from FIG. 17;

FIGS. 20 to 26 and 27A-27J show lateral cross-sectional views of the device from FIG. 17 in different states of activation; and

FIG. 28 shows an exemplary application of the use of an activating device according to the invention for actuating a plurality of water outlets in a shower cabin.

### DETAILED DESCRIPTION

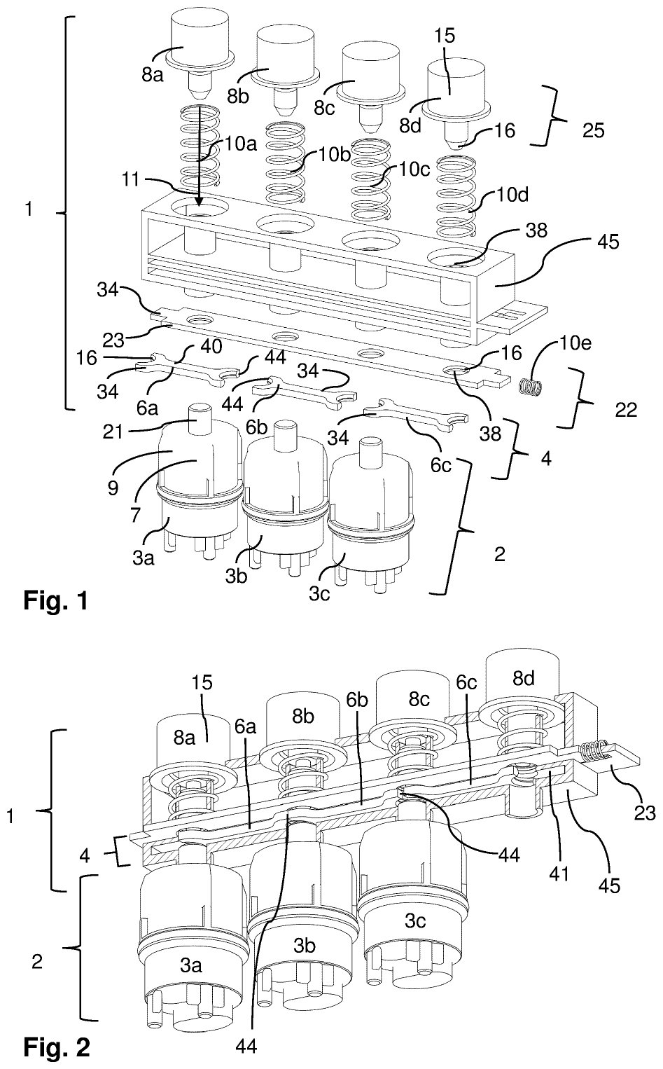

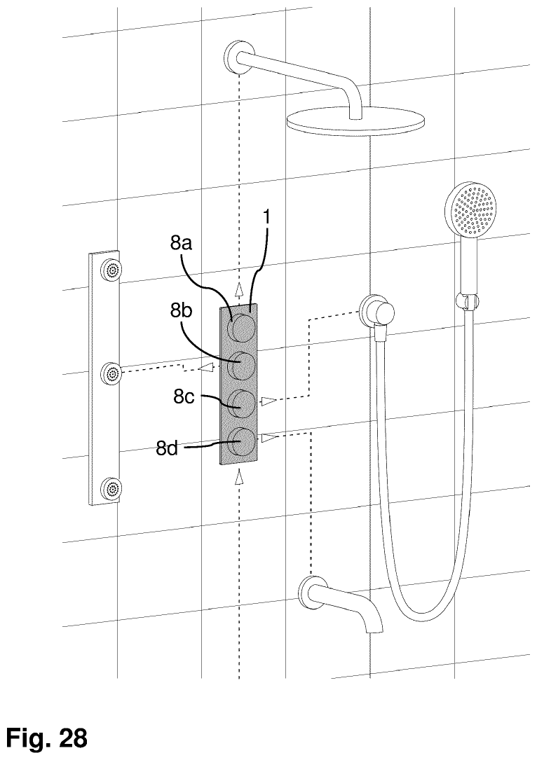

FIGS. 1, 11 and 17 show in each case activating devices 1 according to the invention which serve for activating at least two valves 3a, 3b of a valve assembly 2. Devices of this type can be used to direct water from a central water connection to different water outlets by way of the individual valves, as is illustrated in FIG. 28.

For example, the design embodiment according to FIG. 1 shows a linear disposal of three valves 3a, 3b, 3c, which are in each case configured as self-closing button valves 9, wherein provided for each of the three valves 3 is a respective activating element 8a, 8b, 8c by way of which the respective valve 3 can be opened so that water from a common inlet supplying all valves 3 can flow through the respective opened valve 3 in order to make its way from there to a water outlet.

The three activating elements 8a, 8b, 8c (as well as the further activating element 8d) are in each case configured as push buttons 15 and deflectable counter to the restoring force of a respective restoring element 10. By depressing a respective one of the activating elements 8a, 8b, 8c in the activating direction 11 illustrated in FIG. 4, an actuating force can be transmitted or exerted on a respective actuator element 21 of the assigned valve 3a, 3b, 3c, so that the activated valve 3 is able to be moved to an open position 24 in which water can flow through the valve 3.

The activating device 1 of FIG. 1 furthermore has a shut-off element 4 which in the example of FIG. 1 consists of three separate shut-off parts 6a, 6b, 6c which are in each case configured as a displacement part 34. Moreover, the activating device 1 also comprises a locking element 23 which is likewise designed as a displacement part 34. The locking element 23 as well as the shut-off parts 6a, 6b, 6c are guided in respective guides of a guiding device 45 of the activating device 1. Therefore, these elements can be displaced linearly on respective displacement faces 41 in respective planes which specifically run orthogonally to the common activating direction 11 of the activating elements 8.

As can be seen in FIG. 1, the individual shut-off parts 6a, 6b, 6c have corresponding contact faces 44 by way of which actuating forces are transmittable so that each of the three shut-off parts 6a to 6c can nudge a respective adjacent one of the shut-off parts 6a to 6c. In this way, the shut-off part 6a in FIG. 5, for instance, nudges the shut-off part 6b, and the shut-off part 6b in turn nudges the shut-off part 6c, so that the three shut-off parts 6a to 6c in FIG. 5, driven by the activating movement 17 of the activating element 8a, conjointly move to the right, in the shut-off movement direction 12, to their respective shut-off positions 5a′, 5b′, 5c′. This shut-off movement direction 12 specifically runs transversely to the activating direction of the activating elements 8.

Moreover, the three shut-off parts 6a, 6b, 6c are specifically guided linearly by the guiding device 45 so that movements of the shut-off parts 6a to 6c in the activating direction 11 are currently precluded.

As is shown in the view of FIG. 2, the locking element 23 as well as the shut-off parts 6 form respective reach-through windows 38 through which the activating elements 8 are actuatable and thus can act on the actuator elements 21 of the respective valves 3. It can furthermore be seen in FIG. 2 that the locking element 23 is deflectable counter to the restoring force of the restoring element 10e.

The activating device 1 is specifically designed such that each of the three valves 3a, 3b, 3c can be individually opened by means of the respectively assigned activating element 8a, 8b, 8c. Furthermore, each of the three valves 3a, 3b, 3c is able to be blocked by means of the shut-off element 4, wherein a momentarily blocked valve 3 can currently no longer be opened by depressing the assigned activating element 8, as will yet be explained in more detail.

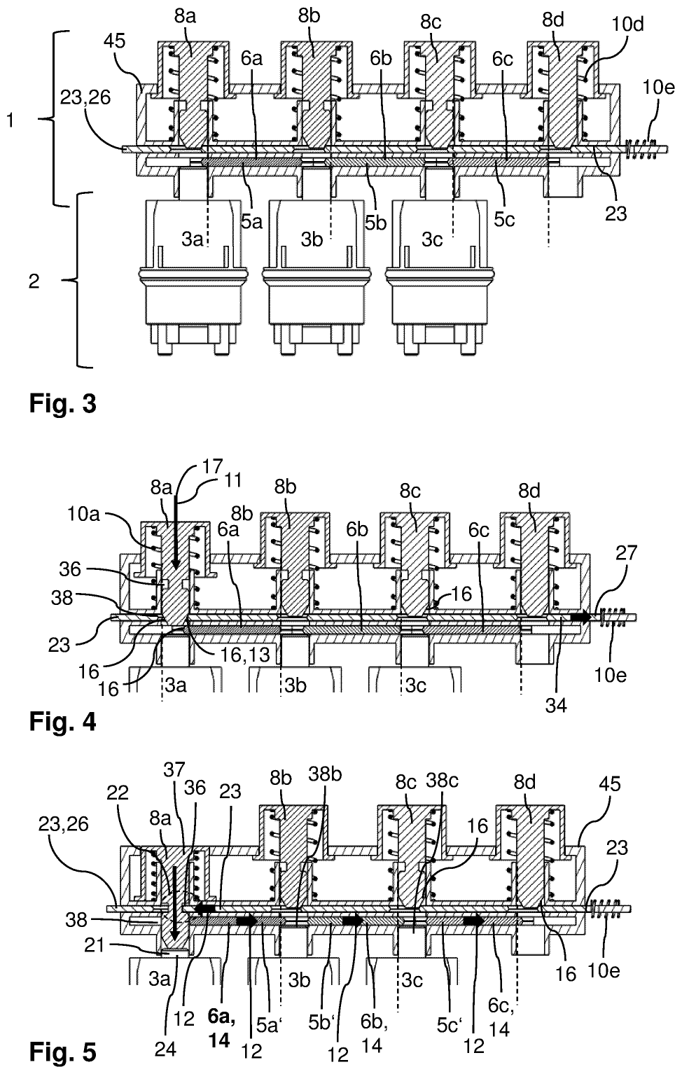

The functional mode of the activating device 1 can be visualized by means of FIGS. 3 to 9 and 10A-10I: FIG. 3 here shows the initial situation in which all four restoring elements 10a-10d are fully deflected so that the respective activating elements 8a to 8d are in a respective uppermost position.

In FIG. 4, the activating element 8a is now actuated by means of an activating movement 17 in the activating direction 11 shown. The activating element 8a, which is of a design identical to that of the further activating elements 8b and 8c, has a cylindrical basic shape with an encircling oblique face 16 at the lower end, the latter configuring a deflecting element 13 so as to deflect the activating force exerted during activation into the plane in which the shut-off parts 6 move. It can furthermore be seen in FIG. 4 that an encircling groove which forms a clearance 36 is configured in a central portion of the activating element 8a.

As is shown in FIG. 4, the oblique face 16 of the activating element 8a first impacts a corresponding oblique face 16 which is configured on the upper periphery of a reach-through window 38, the latter in turn being configured in the locking element 23 (cf. FIG. 1). The activating element 8a by means of the deflecting element 13 thus transmits the activating force to the locking element 23 and thus displaces the latter toward the right (cf. the solid arrow in FIG. 4), so that the locking element 23 is deflected toward the right, counter to the restoring force of the restoring element 10e.

In the further downward movement of the activating element 8a, which is now enabled (thus released) by the lateral movement of the locking element 23, the deflecting element 13 next impacts a further oblique face 16 which is formed on the left upper periphery of the shut-off part 6a (cf. FIG. 1). As a result, the first shut-off part 6a is displaced to the right (in FIG. 5), as a result of which the reach-through window 38 configured in the guiding device 45 is released (on the very left in FIG. 5). As a result, the activating element 8a can now transmit the activating force to the actuator element 21 of the first valve 3a in order for this valve 3a to be opened.

In other words, by activating the valve 3a with the aid of the activating element 8a in the activating direction 11, a shut-off element 4 of the activating device 1 is moved to the shut-off position 5 shown in FIG. 5. This is because the displacement of the first shut-off part 6a causes a further displacement of the shut-off parts 6b and 6c to the shut-off positions 5b′ and 5c′ shown in FIG. 5. In the situation shown in FIG. 5, the first shut-off part 6a blocks the reach-through window 38b, which is assigned to the second activating element 8b, and the second shut-off part 6b blocks the reach-through window 38c, which is assigned to the activating element 8c. As a result, it is specifically achieved that an activation of the two remaining valves 3b and 3c is blocked as soon as the shut-off element 4, i.e. the shut-off parts 6a, 6b, 6c thereof, is/are in the shut-off position 5 illustrated in FIG. 5.

It can furthermore be seen in FIG. 5 that by depressing the first activating element 8a the clearance 36 of the latter (cf. FIG. 4) has been conveyed so as to be level with the locking element 23. Driven by the restoring element 10e, the locking element 23 in the situation shown in FIG. 5 therefore moves in a self-acting manner toward the left and engages in the clearance 36. As a result of this retaining mechanism 22, the valve 3a can be retained in the open position 24 shown in FIG. 5. This is because the activating element 8a is prevented from returning in a self-acting manner to the uppermost position as long as the locking element 23 remains in the locking position 26 illustrated in FIG. 5.

In order for the locking element 23 to now be returned to the releasing position 27 illustrated in FIG. 4, in which the activating element 8a was still displaceable along the activating direction 11, the fourth activating element 8d can now be activated, as is illustrated in FIG. 7. This activating element 8d also has an oblique face 16 on its lower end, and when activated along the activating direction 11 can therefore displace the locking element 23 toward the right, back to the position illustrated in FIG. 7.

By activating the first valve 3a with the help of the activating element 8a, the shut-off parts 6a, 6b, 6c in the situation of FIG. 5 can thus be displaced to their respective shut-off positions 5a′, 5b′, 5c′. In this case (cf. FIG. 5), an activation of the two other valves 3b and 3c is blocked because even when activating the activating element 8b, for instance, the latter can be advanced only up to the first shut-off part 6a, wherein any displacement of the first shut-off part 6a to the left is currently prevented because this movement of the shut-off part 6a is blocked by the first activating element 8a (specifically exactly when the shut-off part 6a is in the ON position 37 shown in FIG. 5, in which the valve 3a is opened).

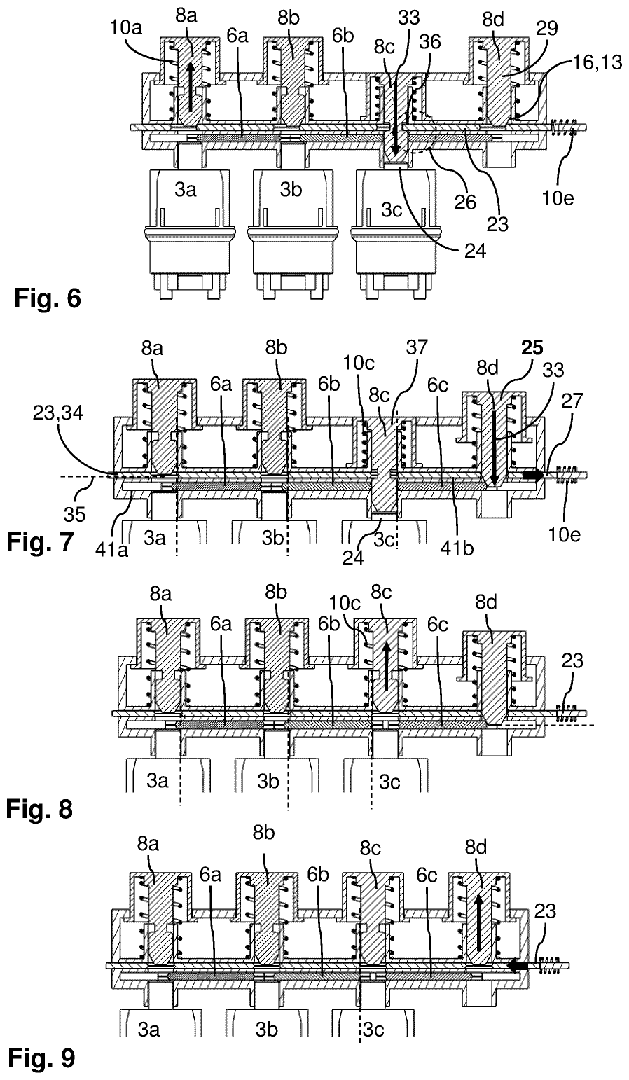

It can furthermore be seen in FIG. 5 that not only the lower oblique face 16 of the fourth activating element 8d, but also the lower oblique face 16 of the third activating element 8c, bears on a corresponding oblique face 16 of the locking element 23. The same applies to the lower oblique face 16 of the second activating element 8b. Therefore, the locking element 23 can be moved to the releasing position 27 also by activating the activating element 8c or the activating element 8b in the activating direction 11. Consequently, the first activating element 8a can return in a self-acting manner to the upper position (by means of the restoring force of the restoring element 10a), as is illustrated in FIG. 6, as a result of which the first valve 3a can currently close again in a self-acting manner.

If the third activating element 8c is now depressed downward further in the direction of the activating direction 11, the situation which is illustrated in FIG. 6 and in which the locking element 23, again driven by the restoring element 10e, engages in the clearance 36 of the activating element 8c and thus retains the valve 3c in the open position 24 shown is created. The activating device 1 is thus specifically configured in such a way that a valve (here valve 3a) which is currently retained in the open position 24 by the retaining mechanism 22 (cf. FIG. 5) is releasable by activating a currently closed valve (here valve 3c). In the process, each of the four activating elements 8a to 8d can be activated as a releasing element 25 so as to release a valve 3 of the valve assembly 2 that is currently locked in the open position 24 by means of a respective releasing movement 33.

It can be seen in FIG. 8 that the locking mechanism of the activating element 8c (cf. FIG. 6) was able to be released by activating the activating element 8d (i.e. the releasing element 25—cf. FIG. 7) so that the activating element 8c, now in FIG. 8, driven by the restoring element 10c is moved upward, thus enabling a self-acting closing of the valve 3c. If the activating element 8d is now let go, as is illustrated in FIG. 9, it also returns to the upper position as a result of which an initial situation similar to that illustrated in FIG. 3 is again achieved.

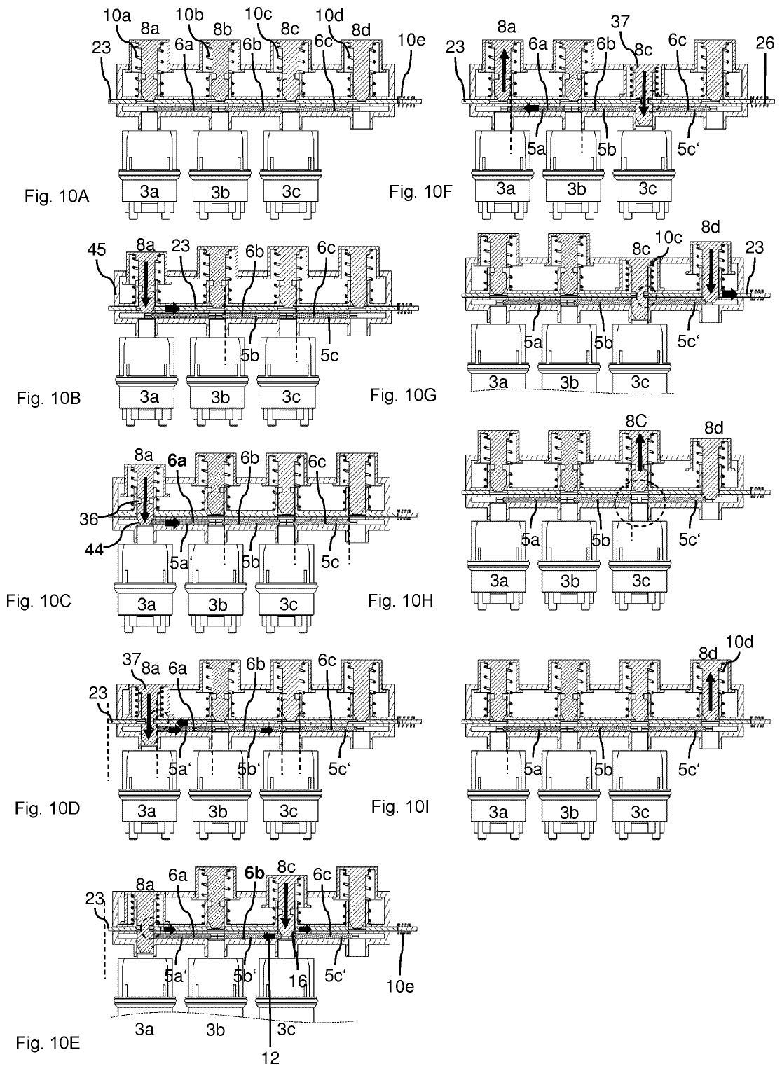

FIGS. 10A-10I once again shows a complete actuating sequence, wherein FIG. 10A shows the initial situation, and the activating element 8a is initially actuated in FIG. 10B. Once the latter has moved the locking element 23 as well as the first shut-off part 6a to the right, the first activating element 8a opens the valve 3a (cf. FIG. 10D). The retaining mechanism 22 here again ensures that the locking element 23 in FIG. 10D locks the activating element 8a in the ON position 37 shown. This locking mechanism is released in FIG. 10E by activating the activating element 8c, because the latter conveys the locking element 23 back toward the right to the releasing position 27. The actuating force exerted on the activating element 8c herein is deflected with the aid of the deflecting element 13 and utilized for compressing the compression spring 10e. As a result of the locking mechanism of the activating element 8a being released, the latter again moves upward in a self-acting manner (FIG. 10F), and after a further downward movement of the activating element 8c, the locking element 23 returns to the locking position 26 so as to now fix the activating element 8c in the ON position 37, as is shown in FIG. 10F. The fixing mechanism of the activating element 8c is subsequently released by activating the activating element 8d, as is shown in FIG. 10G. As a result, the valve 3c can close in a self-acting manner again, as is shown in FIG. 10H. Finally, the activating element 8d, driven by the restoring element 10d, also returns to its initial position, cf. FIG. 10I.

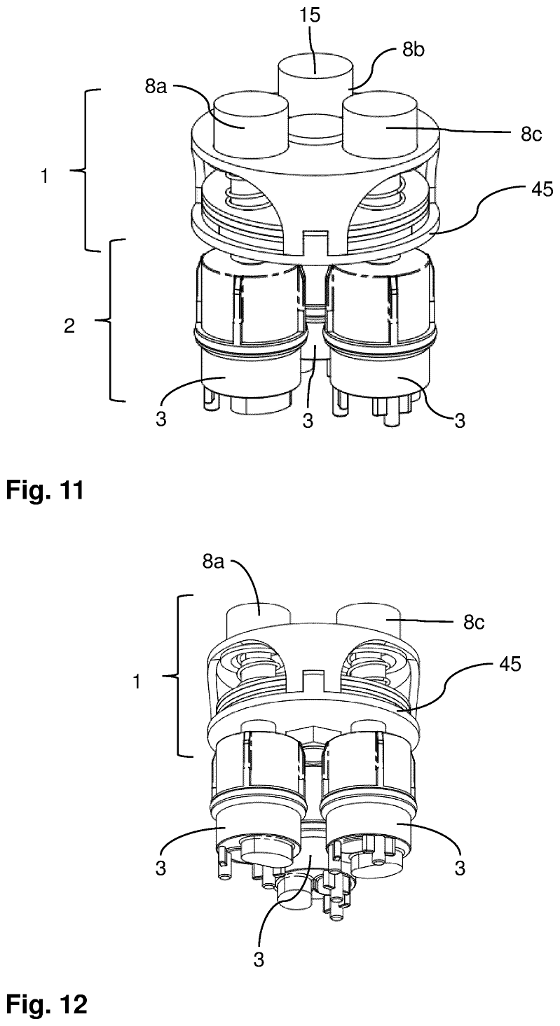

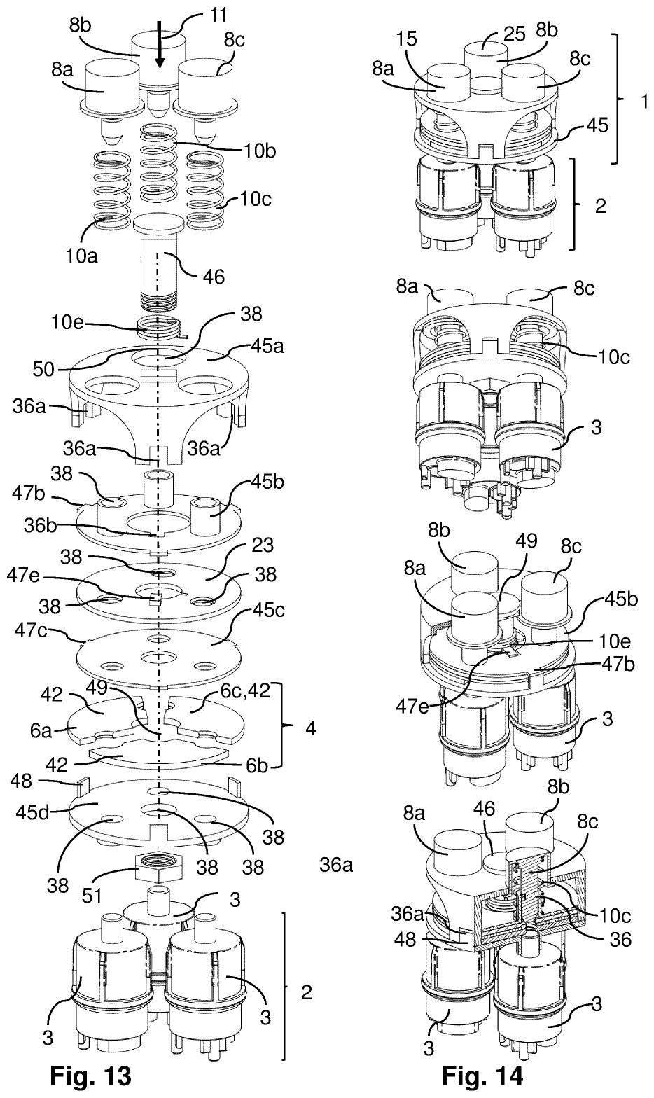

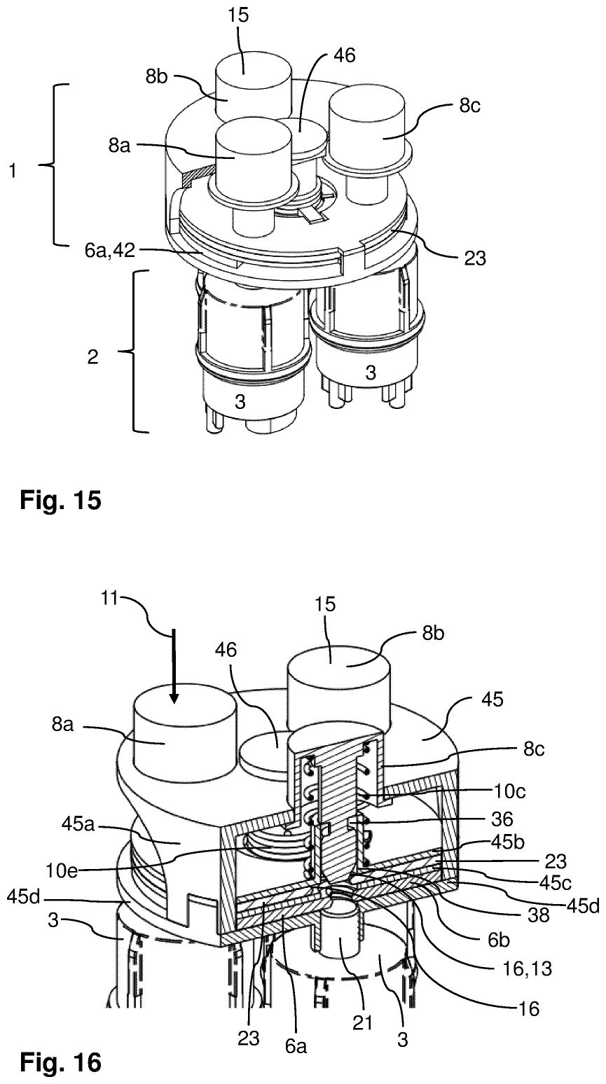

FIG. 11 shows a further potential design embodiment of an activating device 1 according to the invention, wherein, as opposed to FIG. 1, three valves 3 here are no longer disposed in a linear manner but on a circle (cf. also FIG. 12). This second design embodiment also possesses three separate shut-off parts 6a, 6b, 6c which however are in each case designed as pivot parts 42, as can be seen in FIGS. 13 and 14. The activating device 1 furthermore possesses a pivotable locking element 23 in the form of a disk with three reach-through windows 38, one for each of the three activating elements 8a/8b/8c.

The shut-off parts 6a, 6b, 6c as well as the disk-shaped locking element 23 are in each case pivotable/rotatable about a center of rotation 49, i.e. about a common rotation axis 50. For this purpose, the associated guiding device 45 comprises the stationary parts 45a, 45b, 45c and 45d, as well as the likewise stationary fixing means 46 which fixes the entire assembly by means of a lock nut 51 (cf. FIG. 13).

The fixing means 46 moreover holds a restoring element 10e in the form of a rotary spring which serves for rotationally restoring the disk-shaped locking element 23.

Configured on the stationary parts 45b and 45c are protrusions 47b and 47c which in the assembled state according to FIG. 14 engage in the clearances 36a of the stationary part 45a such that the movements of the shut-off parts 6a, 6b, 6c and of the locking element 23 in the activating direction 11 are restricted. Moreover, the part 45d forms three limiters 48 which limit the movements of the parts 6a, 6b, 6c and 23 in the respective pivot plane.

The part 45b offers three reach-through windows 38, on the one hand, and on the other hand a clearance 36b which is configured to be larger than the associated protrusion 47e of the locking element 23. It is achieved by the interaction between the protrusion 47e and the clearance 36b that the rotating movement of the locking element 23 is limited to a tight angular range, for example of less than 15°. By activating one of the three activating elements 8a/8b/8c the locking element 23 can thus be pivoted in the clockwise direction or counter thereto in this angular range, specifically in each case counter to the restoring force of the restoring element 10e. As a result, the locking element 23 can engage in a self-acting manner in respective clearances 36 of the activating elements 8a/8b/8c (cf. FIG. 14 and FIG. 16) so as to lock the activating elements and retain the respectively actuated valve 3 in the open position 24, in a manner analogous to that of the explained retaining mechanism 22 of the first exemplary embodiment according to FIG. 10.

If a respective one of the three activating elements 8a/8b/8c of the design embodiment according to FIG. 11, when actuated by having been depressed/activated, impacts one of the shut-off parts 6a/6b/6c, the corresponding shut-off part is thus pivoted about the center 49 of the assembly (cf. FIG. 13), wherein the associated rotation axis 50 corresponds to the longitudinal axis of the fixing means 46.

The guiding device 45, more specifically the stationary part 45d thereof, of the activating device 1 here forms a face 41 on which the respective shut-off parts 6 are pivotable in relation to the center of rotation 49 of the activating device 1. The three activating elements 8a to 8c are each again configured as push buttons 15 which are deflectable counter to a respective restoring element 10a, 10b, 10c.

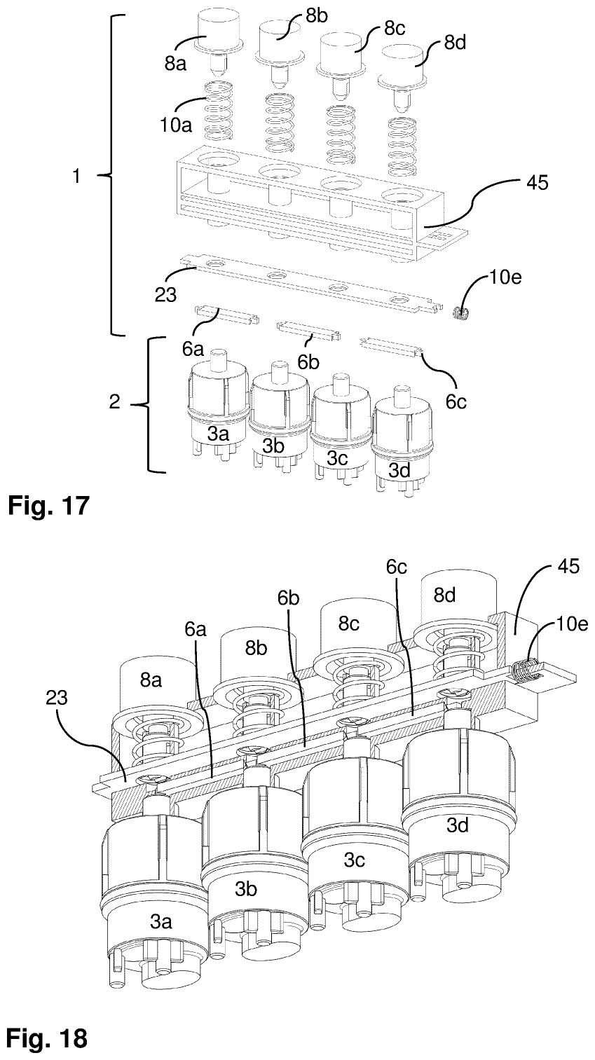

FIGS. 17 and 18 show a third potential design embodiment of an activating device 1 according to the invention. The latter has a total of 4 separate activating elements 8a/8b/8c/8d by way of which a total of four valves 3a/3b/3c/3d of a linear valve assembly 2 can be manually activated or opened, respectively. Therefore, four different water outlets could be actuated by this activating device 1, as is illustrated in an exemplary manner in FIG. 28.

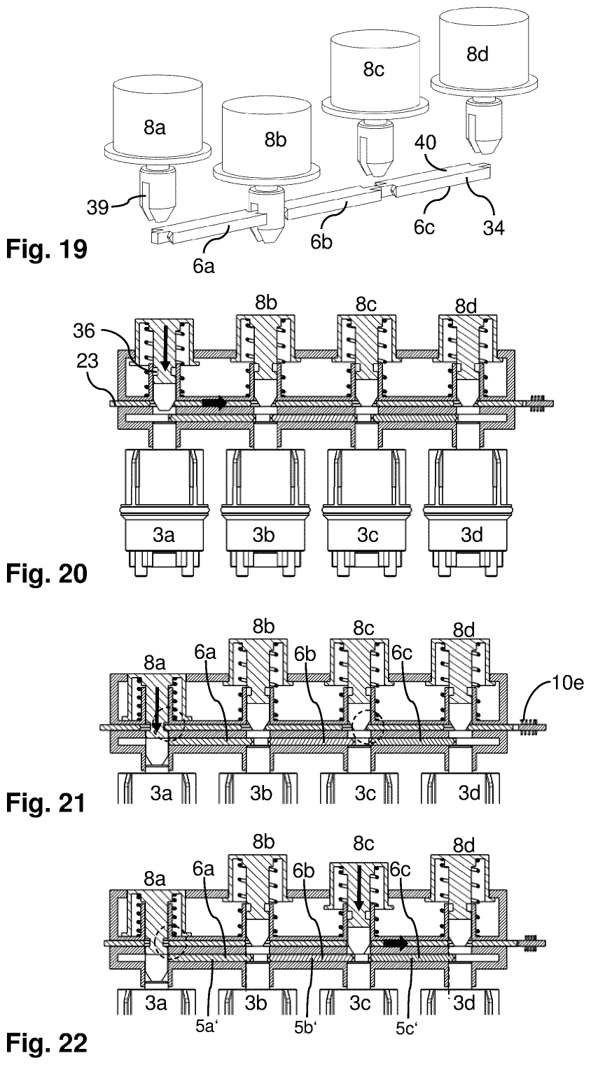

As is shown in FIG. 19, the design embodiment of the activating elements 8a-8d differs from that in FIG. 1. This is because each of the activating elements 8a to 8d in FIG. 19 forms a respective guide 39 for guiding a respective one of the three shut-off parts 6a to 6c. The guide 39 here is specifically designed in such a way that the activating elements 8 can in each case be moved relative to the respective shut-off part 6 in the activating direction 11, even when the respective shut-off part 6 currently engages in the respective activating element 8, as can be seen, for instance, in the activating element 8b in FIG. 19.

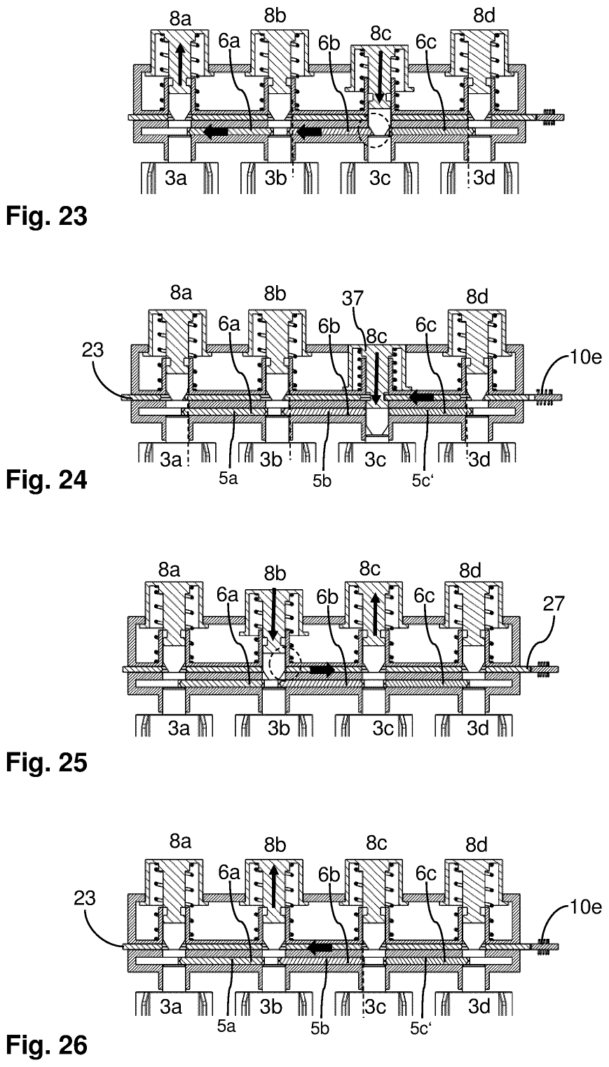

The functional mode of the activating device 1 according to FIGS. 20 to 26 and 27A-27J here is analogous to that of the mechanism explained in the context of FIGS. 3 to 9 and 10A-10I. However, the valve assembly 2 which is used in the third exemplary embodiment according to FIG. 17 has four valves 3a to 3d, wherein the fourth valve 3d is able to be opened with the aid of the fourth activating element 8d. For instance, if the activating element 8c is in the ON position 37, as can be seen in FIG. 24, the locking element 23 by activating any one of the three other activating elements 8a, 8b and 8d can be moved to the releasing position 27 illustrated in FIG. 25. For instance, if the second activating element 8b is used as the releasing element 25, as is shown in FIGS. 25 and 26, the initial situation of FIG. 26 or FIG. 20, in which all four valves 3a to 3d are closed, can be achieved again at any time.

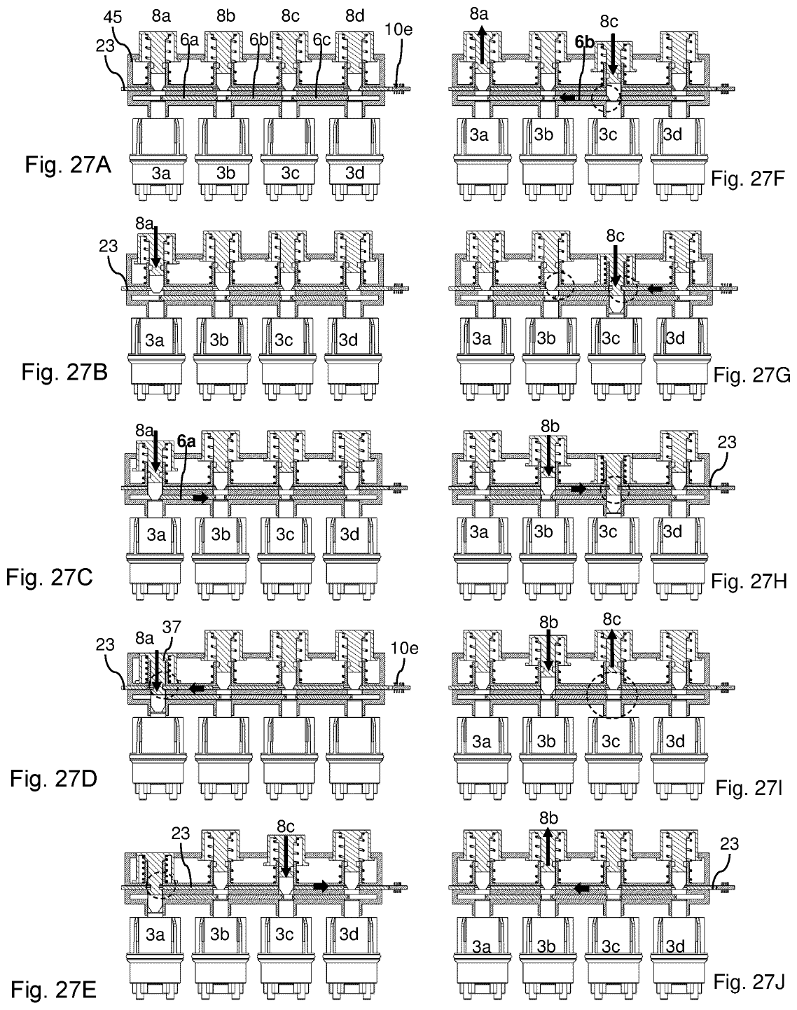

The sequence of actuating the individual valves can take place as illustrated in FIGS. 27A-271, for instance: proceeding from the initial situation shown in FIG. 27A, the activating element 8a is first activated (cf. FIG. 27B) and moved up to the ON position 37 shown in FIG. 27D in which the first valve 3a is retained in the open position 24. The valve 3a can subsequently be closed again by activating the activating element 8c, and the valve 3c can be moved to the open position 24, as is shown in FIG. 27H. After activating the activating element 8b (cf. FIG. 271), the locking mechanism of the activating element 8c (which was still prevalent in FIG. 27H) can also be cancelled again so that the initial position of FIG. 27A is again achieved in FIG. 27J.

Summarizing, it is proposed in order to simplify the operation of a valve assembly 2 which comprises a plurality of valves 3 that respective activating elements 8 which serve for manually opening the valves 3 are temporarily blocked with the aid of at least one shut-off part 6 so that an activation of at least one of the other valves 3 of the valve assembly 2 is currently precluded.

### LIST OF REFERENCE SIGNS

1 Activating device (for activating 3)
2 Valve assembly
3 Valve (of 2)
4 Shut-off element (for shutting off individual valves of 2)
5 Shut-off position
6 Shut-off part (part of 4)
7 Restoring element (for the automatic closing of 3)
8 Activating element (for activating, in particular opening, 3)
9 Button valve
10 Restoring element
11 Activating direction
12 Shut-off movement direction
13 Deflecting element (for transferring from 11 to 12)
14 Shut-off movement
15 Push button
16 Oblique face
17 Activating movement
18 First portion (of 17)
19 Second portion (of 17)
20 Intermediate element (disposed between 8 and 21)
21 Actuator element (for opening 3)
22 Retaining mechanism
23 Locking element
24 Open position (of 3)
25 Releasing element
26 Locking position (of 23)
27 Releasing position (of 23)
28 Fork
29 Initial position (of 25)
30 Latch mechanism
31 Latch
32 Ratchet wheel
33 Locking movement (of 23)
34 Displacement part
35 Locking plane (34 moves in this plane)
36 Clearance (in 8)
37 ON position (of 8)
38 Reach-through window (through which 8 is actuatable unless blocked by 4/6)
39 Guide (in 8 for guiding 6 in the direction of 12)
40 Support face (of 6 for sliding on 41)
41 Displacement face
42 Pivot part
43 Pin
44 Contact face
45 Guiding device
46 Fixing means
47 Protrusion
48 Limiter
49 Center of rotation
50 Rotation axis
51 Lock nut

1. An activating device (1) for activating at least two valves (3) of a valve assembly (2), by activating one of the at least two valves (3) in an activating direction (11), the activating device comprising:
a shut-off element (4) that is movable to a shut-off position (5), wherein the shut-off element (4) comprises multiple of shut-off parts (6a, 6b, 6c);
respective activating elements (8a, 8b, 8c) by which the valves (3) are openable, and the activating elements (8a, 8b, 8c) are adapted to move a respective one of the shut-off parts (6a, 6b, 6c) to the shut-off position (5); and
an activation of at least one of the at least two valves (3) is blocked as soon as the shut-off element (4) is in the shut-off position (5).

2. The activating device (1) as claimed in claim 1,
wherein at least one: a) at least one of the shut-off parts (6a, 6b, 6c) of the shut-off element (4) comprises a sliding part (34) and/or is displaceable to the shut-off position (5); or
at least one of the shut-off parts (6a, 6b, 6c) of the shut-off element (4) comprises a pivot part (42) and/or is pivotable to the shut-off position (5).

3. The activating device (1) as claimed in claim 1, wherein the activating device (2) is for activating the valve assembly (2) having at least three of the valves (3a, 3b, 3c),
wherein the shut-off element (4) has at least two of the shut-off parts (6a, 6b, 6c) which by a respective activation of a respective one of the at least three valves (3a, 3b, 3c) are displaceable to a respective shut-off position (5a, 5b, 5c); and
an activation of at least one of the at least three valves (3a, 3b, 3c) is blocked as soon as one of the shut-off parts (6a, 6b, 6c) is in the respective shut-off position (5a, 5b, 5c).

4. The activating device (1) as claimed in claim 1, wherein the activation of one of the valves (3) causes opening of said valve (3).

5. The activating device (1) as claimed in claim 1, wherein at least one of a) each of the at least two valves (3) is individually openable and closeable via the activating device (1), or
b) each of the at least two valves (3) is blockable by the shut-off element (4).

6. The activating device (1) as claimed in claim 1, wherein during a blockage of a respective one of the valves (3a), opening said blocked valve (3a) by activating the respective activating element (8a) assigned to the blocked valve (3a) is in each case prevented.

7. The activating device (1) according to claim 16, wherein the blockage of the non-activated valves (3) is cancellable by closing a currently open one of the valves (3).

8. The activating device (1) as claimed in claim 1, wherein the shut-off element (4) is in each case movable to the shut-off position (5) in a shut-off movement direction (12) which runs transversely to the activating direction (11).

9. The activating device (1) as claimed in claim 1, wherein the activating elements (8a, 8b, 8c) by which the valves (3) are openable comprise push buttons (15).

10. The activating device (1) as claimed in claim 1, wherein the shut-off parts (6a, 6b, 6c) are in each case movable to two shut-off positions (5a/5a′, 5b/5b′, 5c/5c′) which serve for blocking a respective adjacent one of the valves (3).

11. The activating device (1) as claimed in claim 1, wherein the activating elements (8a, 8b, 8c) are in each case guided in a linear manner so that movements of the activating elements (8a, 8b, 8c) transverse to the activating direction (11) are precluded.

12. The activating device (1) as claimed in claim 1, wherein when simultaneously activating any two of the activating elements (8a, 8b, 8c), all of the valves (3) are blocked by the shut-off element (4).

13. The activating device (1) as claimed in claim 1, wherein at least one of a) the at least two shut-off parts (6a, 6b, 6c) contact and actuate one another when one of the shut-off parts (6a, 6b, 6c) are moved to a respective shut-off position (5a, 5b, 5c) the activating elements (8) penetrate one another, or c) the at least two shut-off parts (6a, 6b, 6c) are in each case guided along the shut-off movement direction (12) in a guide (39) which is formed by the activating elements (8), or d) the at least two shut-off parts (6a, 6b, 6c) have in each case a support face (40) by which the respective shut-off part (6a, 6b, 6c) is mounted so as to be displaceable or pivotable without tilting on a displacement face (41).

14. The activating device (1) as claimed in claim 1, wherein
in each case one said activating element (8a, 8b, 8c) is provided for opening a respective one of the at least two valves (3);
wherein the valves (3) are configured to be self-closing; and
the activating device has a retaining mechanism (22) by which the valves (3) are individually retained in a respective open position (24).

15. The activating device (1) as claimed in claim 14, wherein one of the valves (3a), which is currently retained in the open position (24) by the retaining mechanism (22), is releasable by activating another, currently closed one of the valves (3b); and
the retaining mechanism (22) has a releasing element (25) which is adapted to release each of the valves (3) by a releasing movement (33).

16. The activating device (1) as claimed in either of claim 14, wherein the valves (3) are lockable in the respective open position (24) by at least one of a displacement part (34) or a pivot part (42) of the retaining mechanism (22).

17. The activating device (1) as claimed in claim 16, wherein an activation of at least one of the activating elements (8) is blocked as soon as the at least one of the displacement part (34) or pivot part locks one of the activating elements (8).

18. The activating device (1) as claimed in claim 6, wherein only one of the valves (3) is openable at a specific point in time, because opening one of the valves (3a) causes a blockage of all other ones of the valves (3b, 3c) by the shut-off element (4).

19. The activating device (1) as claimed in claim 1, further comprising a respective deflecting element (13) which converts a linear activation of the activating element (8a) in the activating direction (11) into a respective shut-off movement (14) of at least one of the shut-off parts (6a, 6b) is configured on each of the activating elements (8a, 8b, 8c) for moving a respective one of the shut-off parts (6a, 6b, 6c) by the activating elements (8a, 8b, 8c) to the shut-off position.

20. The activating device (1) as claimed in claim 12, wherein the shut-off element (4) establishes an operative connection between the activating elements (8a, 8b, 8c), and no two of the valves (3) are simultaneously openable.
